(19) United States
(12) Patent Application Publication
(10) Pub. No.: US 2010/0017381 A1
(43) Pub. Date: Jan. 21, 2010

(54) TRIGGERING OF DATABASE SEARCH IN DIRECT AND RELATIONAL MODES

(75) Inventors: Bruce WATSON, Kinburn (CA); Gord HARLING, Bromont (CA); Peter FILLMORE, Kanata (CA); Iain SCOTT, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: AVOCA SEMICONDUCTOR INC., Kanata (CA)

(21) Appl. No.: 12/499,943

(22) Filed: Jul. 9, 2009

Related U.S. Application Data
(60) Provisional application No. 61/129,643, filed on Jul. 9, 2008.

(51) Int. Cl. G06F 7/10; G06F 17/30

(52) U.S. Cl. 707/4; 707/104.1; 707/E17.071; 707/E17.009; 707/E17.101

(57) ABSTRACT

Modern portable electronic devices are commercially available with ever increasing memory capable of storing tens of thousands of song, hundreds of thousands of images, and hundreds of hours of video. The traditional means of selecting and accessing an item within such devices is with a limited number of keys and requires the user to progressively work through a series of lists, some of which may be very large. Provided is a method for speech recognition that allows users to efficiently select their preferred tune, video, or other information using speech rather than cumbersome scrolling through large lists of available material. Users are able to enter search and command terms verbally to these electronic devices and users who cannot remember the correct name of the audio-visual content are supported by searches based on lyrics, tempo, riff, chorus, and so forth. Further, pseudonyms may be associated with audio-visual content by the user to ease recollection. The method also supports local remote retrieval of the correct data associated with a pseudonym for use locally or remotely to establish playback of the audio-visual content.

This application claims the benefit of U.S. Provisional Patent Application No. 61/129,643 filed on Jul. 9, 2008, the entire contents of which are incorporated herein by reference.

### FIELD OF THE INVENTION

The invention relates to databases and more particularly to identifying content within the database from triggers operating in direct and relational modes.

### BACKGROUND OF THE INVENTION

There are a wide variety of modern consumer electronics devices that rely upon microprocessors such as home computers, laptop computers, cellular telephones, personal data assistants (PDA) and personal music devices such as MP3 players. Advances in the technology associated with microprocessors have made these devices less expensive to produce, improved their quality, and increased their functionality. Despite the improvements in microprocessors, the physical user interfaces that these devices use have remained relatively unchanged over the years. Thus, while it is not uncommon for a modern home computer to have a wireless keyboard and mouse, the keyboard and mouse are quite similar to keyboards and mice commonly available a decade ago.

Cellular telephones and PDAs have keypads that are functionally similar to those of analogous devices used many years ago. As the functions that PDAs support are now relatively complex, the keypads that they support increasingly have more keys. This represents a design constraint in that while the size of individual PDAs is reduced the number of keys increases sometimes to the extent that users of these devices often have difficulty pressing keys on the keypad without pressing undesired keys. In some cases, the designers of cellular telephones have avoided this problem by limiting the number of keys on the keypad while at the same time associating specific characters with the pressing of a combination of keys. This solution is difficult for many users to learn and use, due to its complexity.

In many instances, the keypad and keyboard solutions for entering data are impossible for the user to effectively use. This may occur due to a user's disability that can include visual impairment or motion impairment, or simply due to protective equipment worn by the user for the environment the user is working in. In the past decade, the touch-pad has become common in laptops and palmtops, eliminating the need for a separate mouse. A touch-pad senses the motion of the user's finger to provide for motion across the screen and senses a single tap as selection of a predetermined function. Touch-pads have been integrated in some portable devices, such as in the Apple iPod™ touch multi-media player and in the Apple iPhone™ cellular telephone, to provide the user with enhanced accessibility of the applications and the data contained within.

After a decade of development, many devices still offer small flat rectangular touch-pads with simple motion and single tap differentiation. Many other portable electronic devices, particularly MP3 players designed for minimum physical dimensions such as the Apple iPod™ nano, iPod™ shuffle, and iPod™ do not include any kind of text based keypad nor any touch pad. Instead, these devices typically use simple keys for a limited number of functions such as “volume up”, “volume down”, “on/off”, “skip to next track”, and “go back.”

Modern portable electronics such as MP3 players, the iPhone™, and the iPod™ are commercially available with ever increasing memory, for example, Apple currently offers an iPod™ with 160 Gb of memory. Such an iPod™ can store approximately 40,000 songs, 250,000 photos, or 200 hours of video. Accordingly, the traditional means of selecting and accessing an item within such an iPod™ is with a limited number of keys and requires the user to progressively work through a series of lists to find the item they wish to access. Some of these lists may be large, such as a list of artist names or album names.

It would therefore be beneficial for such devices to exploit a speech recognition system that allowed users to efficiently select their preferred tune, video, or other information using speech rather than cumbersome scrolling through large lists of available material. Linguists, scientists, and engineers have endeavored to construct voice recognition systems for many years. Although this goal has been realized, voice recognition systems still encounter difficulties including: the extracting and identifying of the individual sounds that make up human speech; the wide acoustic variations of even a single user according to circumstances; and the presence of noise and the wide differences between individual speakers.

Speech recognition devices that are currently available attempt to minimize these problems and variations by providing only a limited number of functions and capabilities. These are generally classed as “speaker-dependent” or “speaker-independent” systems. A speaker-dependent system is “trained” to a single user's voice by obtaining and storing a database of patterns for each vocabulary word uttered by that user. Disadvantages of a speaker-dependent system are obviously that it is accessible by only a single user (although sometimes this may be an advantage with portable electronics), its vocabulary size is limited to its database, training the system is a time-consuming process, and generally a speaker-dependent system cannot recognize naturally spoken continuous speech.

Although any user can use them without training, speaker-independent systems are typically limited in function and having small vocabularies and needing to have the words spoken in isolation with distinct pauses. Consequently, these systems in general are currently limited to telephony based directory assistance, customer call centre navigation and call routing type applications. In most speaker-independent systems, the word to be spoken is actually given to the user from a short list of options further limiting the vocabulary requirements.

With the development of application specific speech recognition hardware, such as the Sensory Inc RSC-4128 processor, Images SI Inc HM2007 IC, and Voxi's FPGA based Speech Recognizer™ and enhanced transform algorithms, voice recognition is being brought into mainstream applications. Further developments in noise cancellation, enhanced algorithms for the Hidden Markov model (HMM), acoustic modeling, and language modeling are all advancing the breadth of vocabulary, speed of recognition, accuracy of recognition, and speaker independent processing. In many consumer electronic devices, the FPGA circuits performing all the other normal functions can be augmented with the speech recognition software and dedicated processing elements from such hardware implementations. In high volume applications such as MP3 players, cellular telephones, and so forth, the additional speech recognition functionality can be implemented at potentially very low cost.

Current expectations of such speech recognition as applied to devices such as MP3 players, and so forth typically consist of the user speaking either the name of the album or the particular song that they wish to access. Such a speech recognition system would be required to process a significant length of speech from the user with a high degree of accuracy. Additionally, the user would have to know the name of the song, artist, or album in order to select an audio track from the device or must know a similar identifier such as a title in the selection of video or image information.

Accordingly, it would be beneficial if a speech recognition system could provide additional functionality to allow the user to easily select the element they wish to display or play.

### SUMMARY OF THE INVENTION

According to one aspect the invention provides for method for providing to a user a selection of at least one content file of a plurality of content files, the method comprising: storing in a database at least one association between a selection term and at least one content identifier identifying the at least one content file; receiving an audio signal from the user, the audio signal comprising a spoken term; converting the spoken term of the audio signal into a recognized term with use of a speech recognition circuit; searching the database and determining that the recognized term matches the selection term of the at least one association; selecting the at least one content file identified by the at least one content identifier associated with the selection term; and providing to the user the selection from the at least one content file selected.

In some embodiments of the invention, the spoken term is a pseudonym for the selection. In some embodiments of the invention, the pseudonym is a mnemonic.

In some embodiments of the invention, the step of storing comprises receiving from the user as input, the selection term and an identification of content for use in determining the at least one content identifier associated with the selection term.

In some embodiments of the invention, the content identifier comprises metadata associated with the at least one content file.

In some embodiments of the invention, providing to the user the selection from the at least one content file selected comprises: in a case where the at least one content file is a single content file, providing the single content file to the user as the selection; and in a case where the at least one content file is more than a single content file, providing the selection from a list of the at least one content file.

In some embodiments of the invention, the list of the at least one content file comprises data relating to the at least one content file, and wherein providing the selection from a list of the at least one content file comprises: receiving a user selection from the user, the user selection relating to a specific item of the data presented to the user identifying a specific content file of the at least one content file.

In some embodiments of the invention, receiving the user selection from the user comprises receiving at least one of an audible command, a spoken word, an entry via a haptic interface, a facial gesture, a facial expression, and an input based on a motion of an eye of the user.

In some embodiments of the invention, the at least one content file comprises at least one of a document file, an audio file, an image file, a video file, and an audio-visual file.

In some embodiments of the invention, each content file of the selection of at least one content file comprises audio data, and wherein the spoken term is a portion of lyrics.

In some embodiments of the invention, the step of storing comprises for each content file of the at least one content file: converting the audio data into speech data with use of the speech recognition circuit; identifying in the speech data a repeated term greater than a predetermined length; storing the repeated term as the selection term; and storing as the content identifier an identifier identifying the content file.

In some embodiments of the invention, the repeated term is a chorus.

In some embodiments of the invention, the predetermined length is one of a predetermined length of time, a predetermined number of syllables, and a predetermined number of words.

In some embodiments of the invention, the speech recognition circuit is situated in a local device, and wherein providing to the user the selection from the at least one content file selected comprises: transferring to a remote device from the local device the at least one content file selected; and providing to the user from the remote device the at least one content file selected.

In some embodiments of the invention, wherein the speech recognition circuit is situated in a local device, and wherein providing to the user the selection from the at least one content file selected comprises: in a case where the at least one content file is a single content file: transferring to a remote device from the local device the single content file; and providing the single content file to the user from the remote device as the selection; and in a case where the at least one content file is more than a single content file: receiving a user selection from the user, the user selection relating to a specific item of data presented to the user relating to the at least one content file, the user selection identifying a specific content file of the at least one content file; transferring to the remote device from the local device the specific content file; and providing the specific content file to the user from the remote device as the selection.

In some embodiments of the invention, the speech recognition circuit is situated in a local device, wherein the plurality of content files are stored in a remote device, and wherein selecting the at least one content file comprises: transferring the at least one content identifier to the remote device; and selecting the at least one content file stored in the remote device identified by the at least one identifier associated with the selection term.

In some embodiments of the invention, providing to the user the selection from the at least one content file selected comprises: in a case where the at least one content file is a single content file, providing the single content file on the remote device to the user as the selection; and in a case where the at least one content file is more than a single content file, providing the selection from a list of the at least one content file.

In some embodiments of the invention, the list of the at least one content file comprises data relating to the at least one content file, and wherein providing the selection from a list of the at least one content file comprises: transferring the data relating to the at least one content file from the remote device to the local device; receiving a user selection from the user, the user selection relating to a specific item of the data presented to the user identifying a specific content file of the at least one content file; transferring the user selection from the local device to the remote device; and providing on the remote device the specific content file identified by the user selection to the user as the selection.

In some embodiments of the invention, the step of storing in a database comprises: identifying each content file of the plurality of content files stored in the remote device; and generating the at least one content identifier identifying the at least one content file of the database from the identification of each content file of the plurality of content files.

According to another aspect, the invention provides for a method for providing to a user a selection of at least one content file of a plurality of content files, each content file of the at least one content file comprising audio data, the method comprising: receiving an audio signal from the user; converting the audio signal into a digital representation with use of an audio circuit; searching the plurality of content files and determining that the digital representation matches a portion of the audio data of the at least one content file; selecting the at least one content file; and providing to the user the at least one content file selected as the selection.

In some embodiments of the invention, the audio data comprises music and the audio signal comprises vocalized music. In some embodiments of the invention, the vocalized music comprises at least one of a beat, a tempo, and a riff.

In some embodiments of the invention, determining that the digital representation matches a portion of the audio data comprises: extracting an input base form timing from the vocalized music of the digital representation and determining if the input base form timing matches a base form timing of the music of the audio data.

In some embodiments of the invention, the audio data comprises a song and the audio signal comprises user lyrics, wherein converting the audio signal into a digital representation is performed with use of a speech recognition circuit, wherein and digital representation comprises recognized lyrics converted by the speech recognition circuit from the user lyrics, and wherein determining that the digital representation matches a portion of the audio data comprises: extracting speech data from the song of the audio data and determining that the recognized lyrics match a portion of the speech data.

### BRIEF DESCRIPTION OF THE DRAWINGS

Exemplary embodiments of the invention will now be described in conjunction with the following drawings, in which:

FIG. 1 illustrates two current commercially dominant portable music players and their user interfaces;

FIG. 2 illustrates a variety of other current music players supporting digital music formats;

FIG. 3 illustrates user interfaces for a commercially successful compact MP3 player according to the prior art;

FIG. 4A illustrates a prior art interface for identifying and selecting content from a database of audio-visual content;

FIG. 4B illustrates a prior art hierarchical search employed in audio-visual display devices;

FIG. 5 illustrates approaches for enhanced user interfaces for audio-visual devices according to the prior art;

FIG. 6 illustrates a prior art speech recognition system based upon remote server processing;

FIG. 7 illustrates a prior art dedicated speech recognition integrated circuit for adding speech recognition functionality to portable electronic devices;

FIG. 8A illustrates a first embodiment of the invention by displaying criteria for selecting audio-visual content from a database of audio-visual content;

FIG. 8B illustrates a second embodiment of the invention wherein user generated pseudonyms are employed to retrieve audio-visual content;

FIG. 9A illustrates a third embodiment of the invention by displaying audio-visual content selection based upon the audio-visual content directly;

FIG. 9B illustrates a fourth embodiment of the invention wherein a “chorus” is extracted for matching audio-visual content based upon the users input;

FIG. 10 illustrates a fifth embodiment of the invention by displaying audio-visual content selection based upon a non-speech based aspect of the audio-visual content; and

FIG. 11 illustrates a fourth embodiment of the invention wherein a portable electronic device with speech recognition interfaces to other audio-visual content devices to control them based upon input user speech.

### DETAILED DESCRIPTION OF EMBODIMENTS OF THE INVENTION

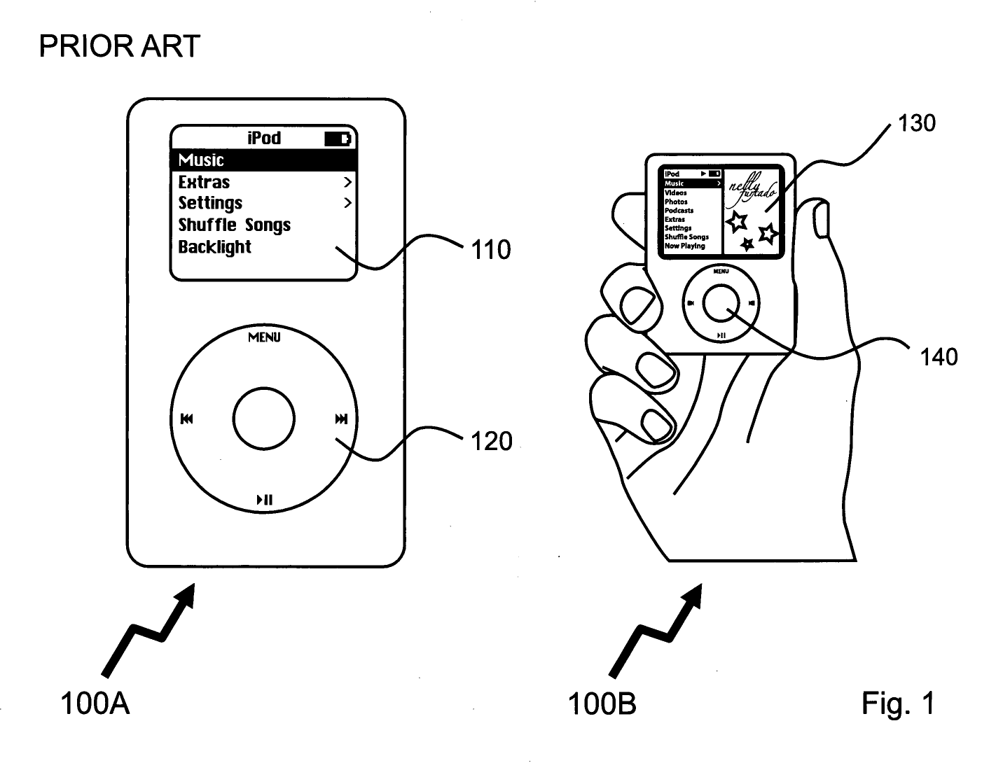

Referring to FIG. 1 there are shown two highly commercially successful audio-visual content devices, these being the Apple® iPod™ classic 100A and Apple® iPod™ nano 100B. The iPod™ classic 100A provides the user with a display 110 upon which text based information is presented to allow the user to select the content stored within the iPod™ classic 100A for play back to the user. The user may control the selection process through the simple wheel controller 120 which provides the ability to scroll through lists and move up/down through a hierarchy of lists.

Similarly, iPod™ nano 100B has an LCD display 130 that guides the user with simple information relating to the content of the iPod™ nano 100B, the specific content to be retrieved selected in response to the user actions with the controller 140. The controller 140 has the same functionality and design as the wheel controller 120 wherein the wheel engages four switches, which are labeled in clockwise order “Menu”, [symbol] for back/beginning, [symbol] for play/pause, and [symbol] for forward/end. Moving a users finger or thumb in sequence either clockwise or counter-clockwise results in the menu displayed being scrolled through.

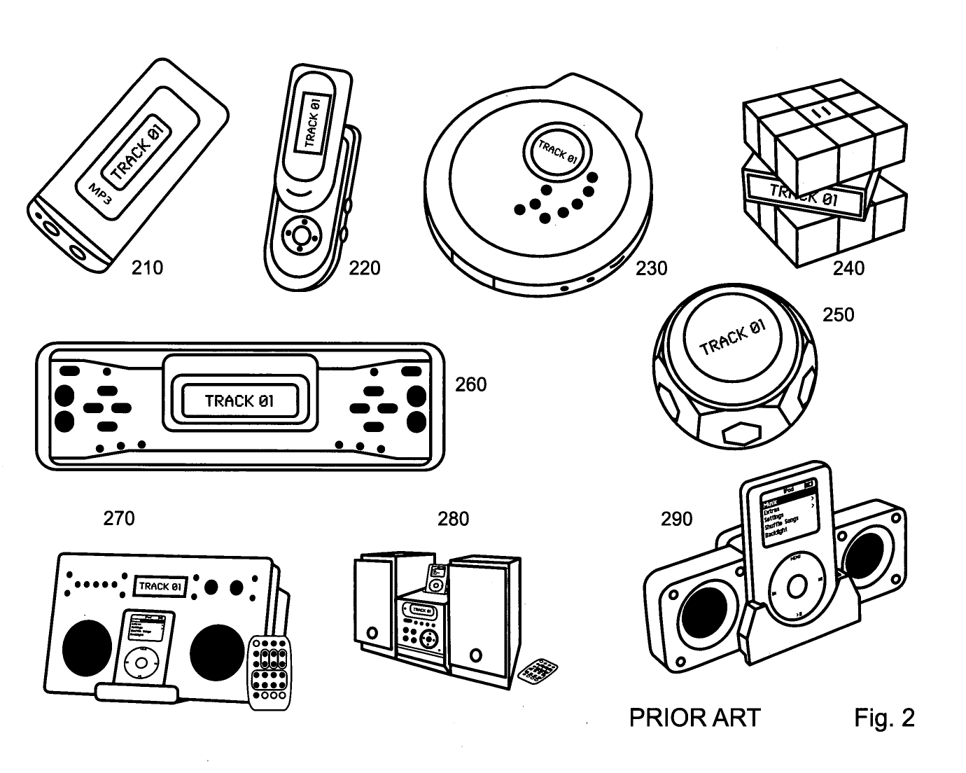

However, as is evident from FIG. 2 there are a wide variety of digital audio content players, such as MP3 players 210 and 220 that have more limited interfaces for the user including switches such as [symbol] for back/beginning, [symbol] for forward/end, “+” for increasing volume, and “−” for decreasing volume. As such, MP3 players 210 and 220 offer no ability to dynamically navigate the database of content. Equally, other portable MP3 players such as digital Walkman 230 provide limited standalone player functionality intended for use within the office, domestic environments and so forth such as puzzle player 240 and ball player 350. Similarly, car audio player 260 provides limited functionality in respect of playing digital content from a disc (not shown for clarity) or an MP3 player (not shown for clarity also) connected to an auxiliary input port of the car audio player 260. Within this latter scenario, the selection of content is typically determined by the user's actions with the MP3 player. If this is for example an iPod™ classic 210 then the user has some additional search and selection capabilities over the car audio player 260.

Also shown is a docking station that accepts an iPod™ such as an iPod™ classic 110 and provides for re-charging of the iPod™ batteries and free standing loudspeakers. Audio player 270 takes this further and provides an alarm clock function as well as including an AM/FM radio. Finally, shelf audio system 280 is a full audio system with CD player, radio, standalone speakers, and in some instances (not shown) cassette player and external turntable. With these systems, the displays are typically 7-segment LCD based and hence poorly suited to displaying the contents of the MP3 player.

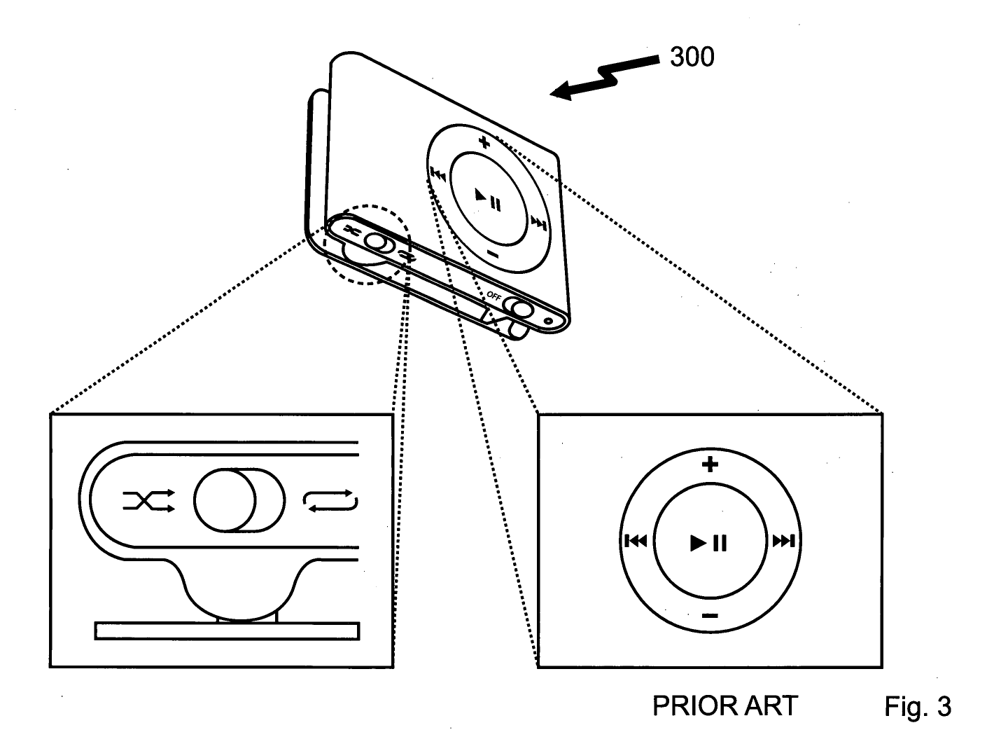

Referring to FIG. 3 there is shown an iPod™ shuffle 300 to show a feature added to such devices to remove the predictability of the user always listening to the songs in the order they were selected and transferred to the iPod™ shuffle 300. Hence in addition to the wheel controller 310 there is provided a switch 320 which adjusts operation of the iPod™ shuffle from sequential in position A 324, wherein the songs play in order unless skipped or reversed by the user via the wheel controller 310, to shuffle in position B 322, wherein the songs are played in a pseudo-random manner thereby offering some degree of variation.

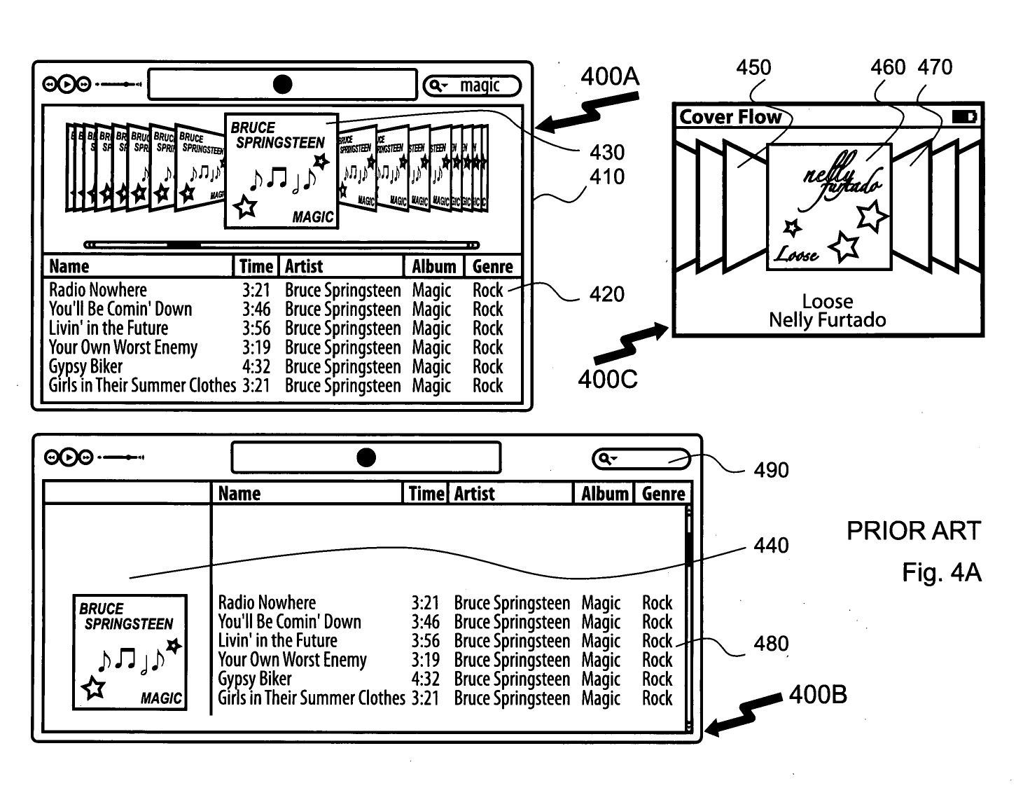

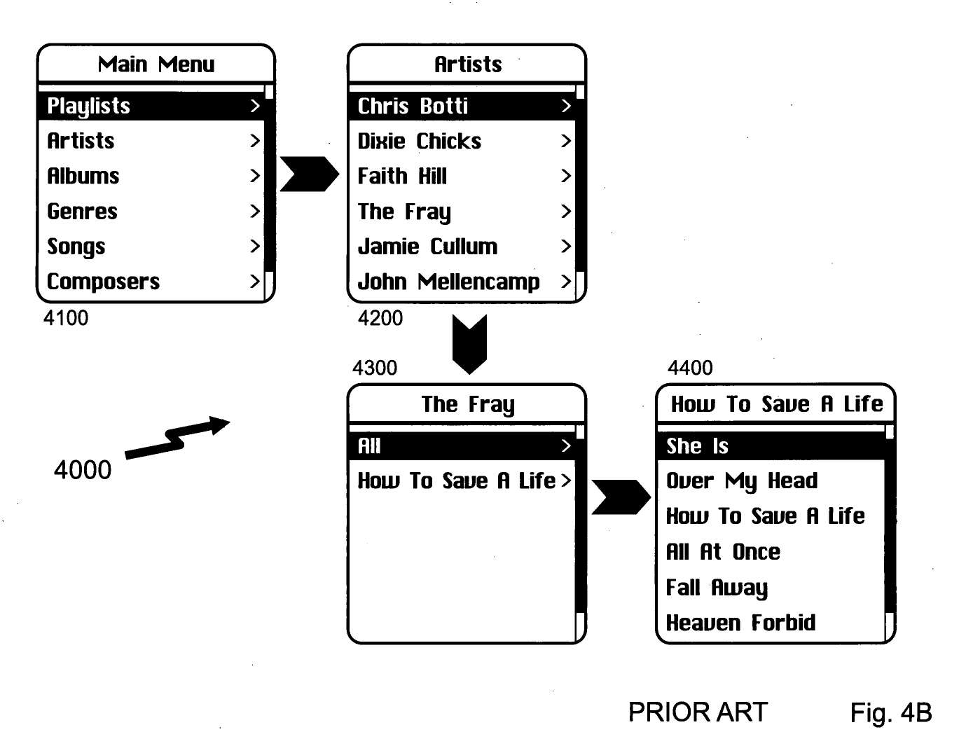

The user will typically transfer their audio-visual content from a computer, such as their laptop or desktop computer using a commercial software package, such as Apple iTunes™, Winamp™, and Windows Media Player. Accordingly the user will typically be selecting music, be it for transferring to a portable media player or playing their audio-visual content through a software window such as cover flow list 400A, list 400B or solely cover flow 400C as displayed within FIG. 4A. In cover flow list 400A, the upper portion 410 of the window displays an image associated with each group of audio-visual elements, for example the cover of a CD, DVD and so forth, and in the lower portion 420 presents a list of the specific content within the currently central audio-visual group 430.

In list 400B, the user is presented with multiple group audio-visual elements as both listed elements 480 and representative images 440. Typically, multiple grouped entries to the database will be visible unless the particular list of listed elements 480 is particularly large. By selecting an item from the listed elements 480, the highlighted audio-visual content may be played, deleted, added to a playlist, or added to a list for transfer to an MP3 player, or other functions supported by the application in use. Alternatively, the user may simply exploit cover flow 400C wherein only the images of grouped audio-visual content are presented to the user. The user may, via keyboard, mouse, or other control element “flip” backwards and forwards essentially through virtual pages of a book with previous image 470, current image 460, and next page 450 to find the grouped content the user wishes to access. It would be evident that these require the user to have a good memory to associate a particular element (song, video clip, image, etc.) with a particular grouping (i.e. album, video, event, etc.) although at the upper right of the cover list 400A and list 400B there is a search entry point 490.

Upon a typical portable electronic device the user will generally have to navigate using either cover flow 400C, when the user's portable electronic device supports both through display and application, e.g. iTunes™, or by navigating a series of menus within a hierarchy established by the application. The flow of such a hierarchy is shown by 4000 of FIG. 4B, where the user first encounters a top list 4100 of audio-visual media types, which in this case are limited solely to audio and include for example playlists (lists of audio-visual content the user has created from an application such as iTunes™), artists, albums, genre, songs, composers and so forth. The user selects artists from top list 4100 and is presented with first hierarchy level 4200 wherein for the selection of artists the artists whose music is stored within the user's portable electronic device are listed alphabetically to the user. Upon selecting “The Fray” the user is presented with second hierarchy level 4300 where the options are “All” being all music by the artist stored and “How to Save a Life” being an album by “The Fray” which has been stored either in part or in whole. Selecting “How to Save a Life” then leads the user to third hierarchy level 4400 wherein the individual tracks of the album that have been stored are listed. Now selecting for example “She Is” will result in that individual track being played.

Clearly accessing a specific element of content is quite cumbersome and requires the user to have a good memory of one or more of the artist, title, album and so forth to find the content within the hierarchal lists on the user's portable electronic device. On devices such as cellular telephones and PDAs, the task is in some ways a little easier as the user has access to a keyboard, implemented either as a full keyboard or by multiple selection on a limited number of keys, to enter text rather than operate with lists. However, as the desire in many consumer electronic devices is to minimize cost other approaches have been considered to provide increased functionality within a simple haptic entry format such as a touchpad.

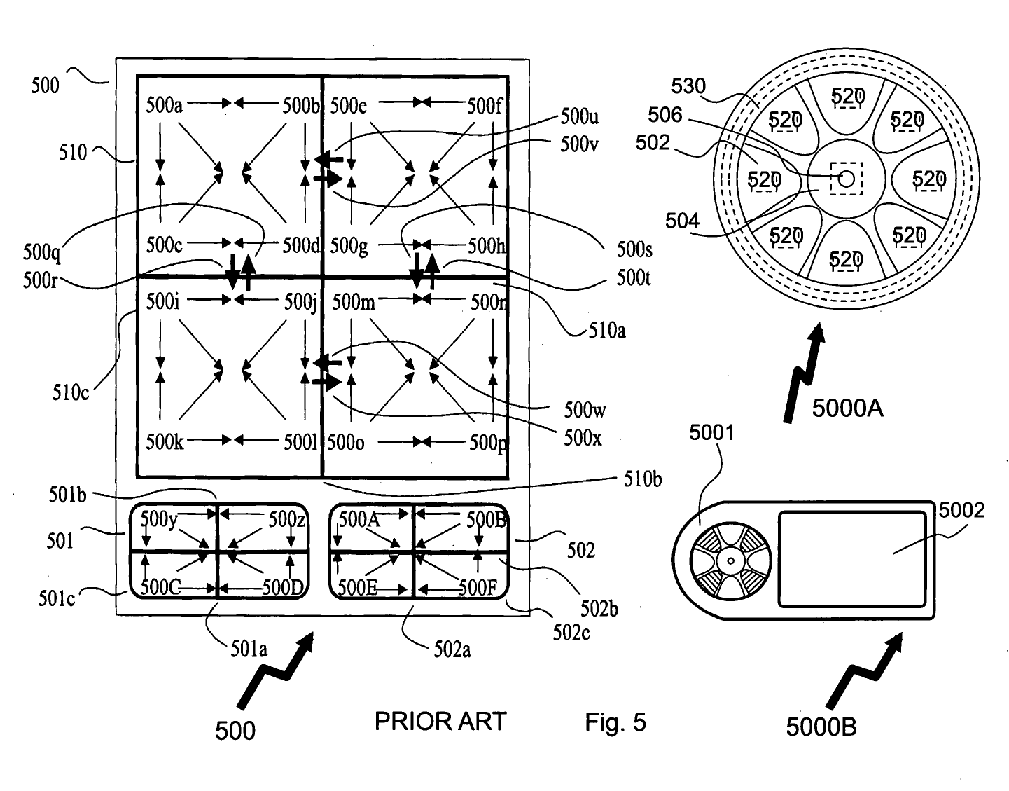

Outlined in FIG. 5 are two such approaches, the first shown as touchpad 5000A and as part of an MP3 player 5000B. The approach patented by Microsoft Corporation (U.S. Pat. No. 6,967,642 “Input Device with Pattern and Tactile Feedback for Computer Input and Control”) provides an increased complexity by dividing the rotary touchpad into eight touch elements 502 arranged in a circular patent, with central touch element 504 and sweet spot 506. Within each, an area 520 is active allowing clear differentiation between the elements when accessed by the user with their finger, thumb, tongue, or other implement. Additionally a circular touch element 530 is provided at the periphery. The touchpad 5000A is shown thereafter as entry device 5001 of the MP3 player 5000B together with the display 5002. As such, the touchpad 5000A does not differ substantially from the simple wheel controller 120 of FIG. 1 but replaces four mechanical switches with a touchpad. As such, the controller may be implemented as part of the display using touch-sensitive screen technology.

The second approach of haptic entry, implemented in device 500 by Zaborowski (US Patent Application 2007/0188474 “Touch Sensitive Motion Device”) again exploits a touchpad but now through the provision of surface features. Hence first touch pad 510 is defined by a boundary feature 510c, for example a small bump within the glass of the touch pad or an overlay, and two other features 510a and 510b. Accordingly the motion of the users finger over the first touch pad 510 may be constrained within one quadrant, such as motions 500a left, 500a down, 500a diagonal, and corresponding three motions for each of 500b, 500c and 500d, or it may be motion from one quadrant to another such as 500u, 500v between upper pair of quadrants, 500w, 500x between lower pair of quadrants, 500q, 500r between the left pair of quadrants, and 500s, 500t between the right pair of quadrants. Accordingly, a simple overlay provides 56 distinguishable motions thereby allowing all characters and numbers to be entered by associating motions with specific characters and numbers. Such a first touch pad 510 obviates the requirement potentially therefore of a keyboard as part of the portable electronic device.

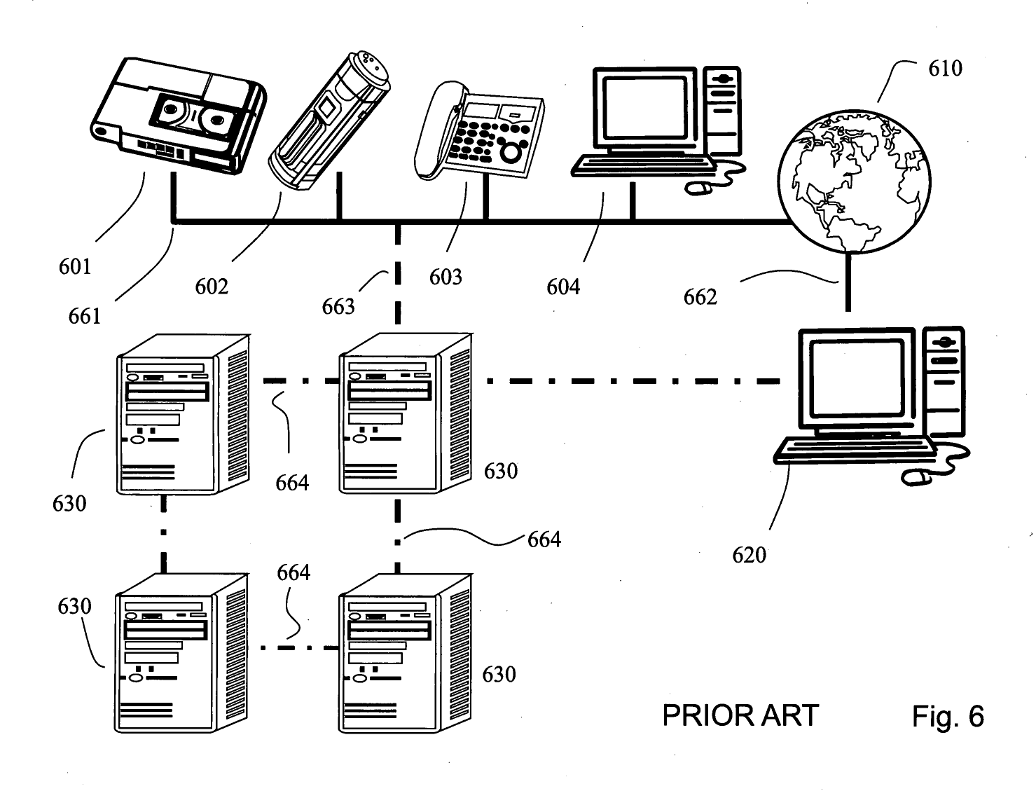

Both approaches aim to address the issue of providing users with either enhanced functions or alphanumeric entry from simplified entry devices other than a keypad or keyboard. However, to date the majority of developments in portable electronic devices, user interfaces and applications have focused on haptic selection of audio-visual content by the user. It would be beneficial to exploit speech from the user to access audio-visual content and adjust parameters of performance for the portable electronic device. Currently, a typical example of speech recognition according to the prior art is one typically deployed within an environment of networking with high power microprocessor access. Such an environment is shown in FIG. 6 where there are several user entry formats for speech, such as a dictation machine at a user's desk 601, a portable dictation machine 602, a PABX telephone 603, and a dedicated online computer access point 604. All of these in the embodiment shown are interfaced to a LAN network 661, which for example operate via TCP/IP protocols.

As shown, the dedicated online computer access point 604 can provide direct real-time transfer but with multiple users and complex language transcription can become overloaded. The dictation machine 601, portable dictation machine 602, and PABX telephone 603 are connected to the LAN network 661 for transfer of digitized speech files to either the dedicated online computer access point 604 or to remote transcription servers 630.

Interconnection of the LAN network 661 is either via a direct LAN connection 663 or through the World Wide Web 662. In the case of a World Wide Web connection 662, the digitized speech is first transmitted via the remote connection system 620 to the remote transcription servers 630. As shown the array of a second LAN network 664 interconnects remote transcription servers 630.

A typical requirement of many prior art software applications loaded onto either the dedicated online recognition system 604 or the remote transcription servers is that they be configured with high-end processors and large memory. However, currently a typical recommended minimum system configuration for widely deployed commercial speech recognition software such as “Dragon NaturallySpeaking”™ is a very low minimum requirement of a 500 MHz processor, 256 MB RAM, and 500 MB non-volatile memory. Microprocessors exceeding these specifications are now common in most portable electronic devices such as cellular telephones, PDAs, multi-media players, and so forth.

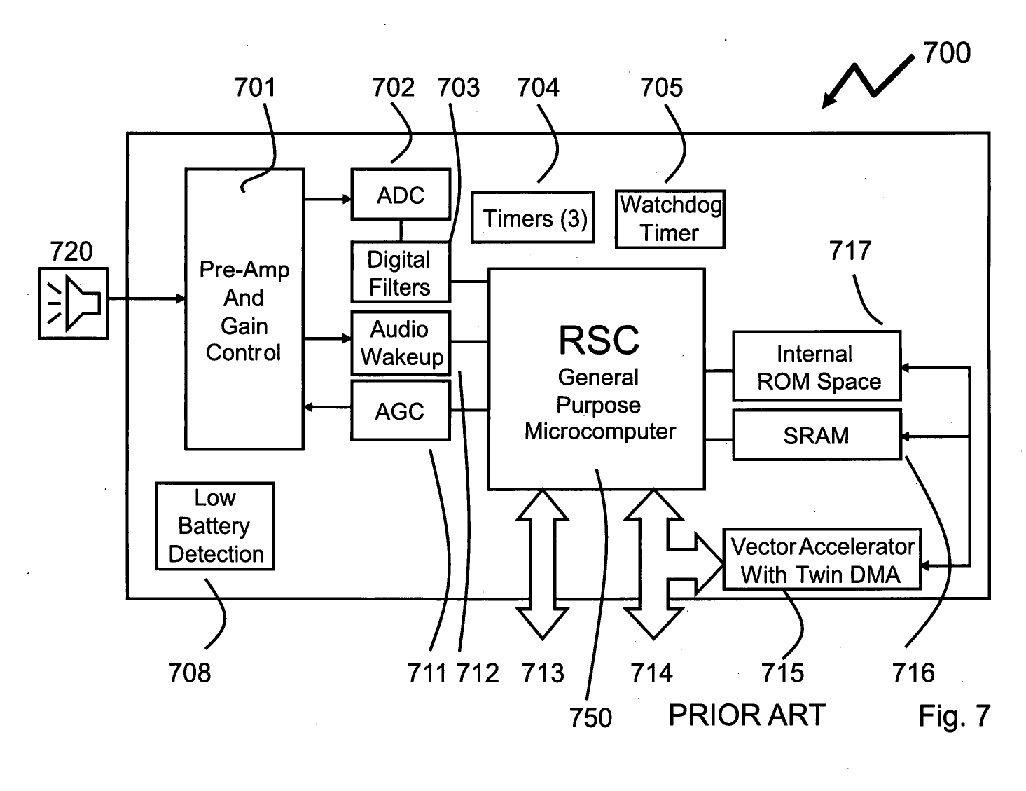

In some circumstances the performance of the portable electronic device may warrant the addition of a dedicated processor to the device to handle speech recognition, for example the Apple iPhone™, Research in Motion Blackberry™, and so forth where speech recognition may be employed to not only select audio-visual content but select all other functions of the device, generate text messages, generate email and so forth. Such a dedicated peripheral processor 700 is shown in FIG. 7, and provides an off-loading of the speech recognition from a microprocessor within a device. Shown is a microphone 720 which receives the user's speech and provides the analog signal to a pre-amplifier and gain control circuit 701 which provides a conditioning of the circuit so that the analog signal is within a predetermined acceptable range for the subsequent analog-to-digital conversion performed by the ADC block 702. Such conditioning provides for maximum dynamic range of sampling.

The digitally sampled signal is then passed through appropriate digital filtering 703 before being coupled to the core general-purpose microprocessor (RSC) 750, which performs the bulk of the processing. As shown the RSC is externally coupled by data bus 713 to the device requiring speech recognition, not shown for clarity. The RSC also has a second data bus 714 which is connected internally within the dedicated peripheral microprocessor 700 to a vector accelerator circuit 715 as well as facilitating additional external processing support with the external aspect of the data bus 714.

In order to perform the speech recognition, the RSC 750 is electrically coupled to ROM 717 and SRAM 716, which contain user defined vocabulary, language information and other aspects of the software required for the RSC 750. The ROM 717 and SRAM 716 also are electrically connected to the vector accelerator circuit 715, which provides for specific mathematical functions within the speech recognition, which are best, further offloaded from the RSC 750.

The RSC 750 is also electrically coupled to the pre-amplifier and gain control circuit 701 directly to provide an audio-wakeup trigger from the audio-wakeup circuit 712 in the event the RSC 750 has gone into standby mode and then a user speaks. Further, the RSC 750 provides control signals back to the pre-amplifier and gain control circuit 701 via the automatic gain control circuit 711.

Additionally the dedicated peripheral processor 700 contains timing circuits 705 and low battery detection circuit 708. Such solutions today typically operate at sampling rates of 1 kHz such that the audio signal is broken into 10 ms elements, which are then digitized giving sampling rates typically of 8 kb/s. The output of the digital signal processing circuit, dedicated peripheral processor 700, would typically be fed to a buffer memory, not shown for clarity, where the processed audio signal is stored pending forwarding to a labeler circuit, also not shown for clarity.

A labeler circuit upon receiving the processed audio signal undertakes a first stage identification of the forwarded process audio segment, the first stage identification being one of many possible approaches including forward prediction based upon previous identified phoneme or word, consonant or vowel classification based upon spectral content, priority tagging and phoneme position within processed audio signal. The output of the labeler circuit may then be fed forward to buffer memory for storage pending a request to forward the processed audio signal to a Viterbi decoder, not shown for clarity.

The Viterbi decoder operates using a Viterbi algorithm, namely a dynamic programming algorithm for finding the most likely sequence of a set of possible hidden states. Commonly the Viterbi decoder will operate in the context of hidden Markov models (HMM). Typically, the Viterbi decoder operating upon an algorithm for solving HMM makes a number of assumptions. These can include, but are not limited to, the observed events and hidden events are in a sequence, the sequence corresponds to time, the sequences need to be aligned, and that an observed event needs to correspond to exactly one hidden event. Additionally the computing may make the assumption that the most likely hidden sequence up to a certain point t must depend only on the observed event at point t, and the most likely sequence at point t−1. These assumptions would all be satisfied in a first-order hidden Markov model.

In this manner the speech is analyzed and the words established from the HMM are either stored within memory until the whole phrase has been decoded or employed immediately. The decision upon storing or executing immediately may be established in dependence of the current state of the application in execution upon the portable electronic device. For example, in the case of an audio-visual player the response of the user at a point in the application where the user is selecting an aspect for filtering may be acted upon immediately, whereas if the device is expecting the name of an artist or song then the processed words may be stored until the point that the device decides the user has completed their entry and then extracted for use within the application.

As described hereinabove, it would be beneficial if a speech recognition system could provide additional functionality to allow the user to easily select the element they wish to display or play.

Such functionality for example could include the ability to select elements based upon a broader range of criteria associated with the elements or user defined criteria, presenting options when recognition is not completely accurate, adapting the presentation of options based upon user preferences or user history, allowing the user to select from options based upon audio triggers rather than manual entry, and allowing new approaches to recognizing the element to be presented to the user.

It would also be beneficial for the user to be able to use a portable consumer electronic device, such as an iPod™ or cellular telephone, as the controller for another electronic system such as a shelf audio system, personal video recorder, digital set-top box, digital picture frame, and so forth wherein such devices accept digital control information determined from the audio processed instructions of the user provided to the portable consumer electronic device.

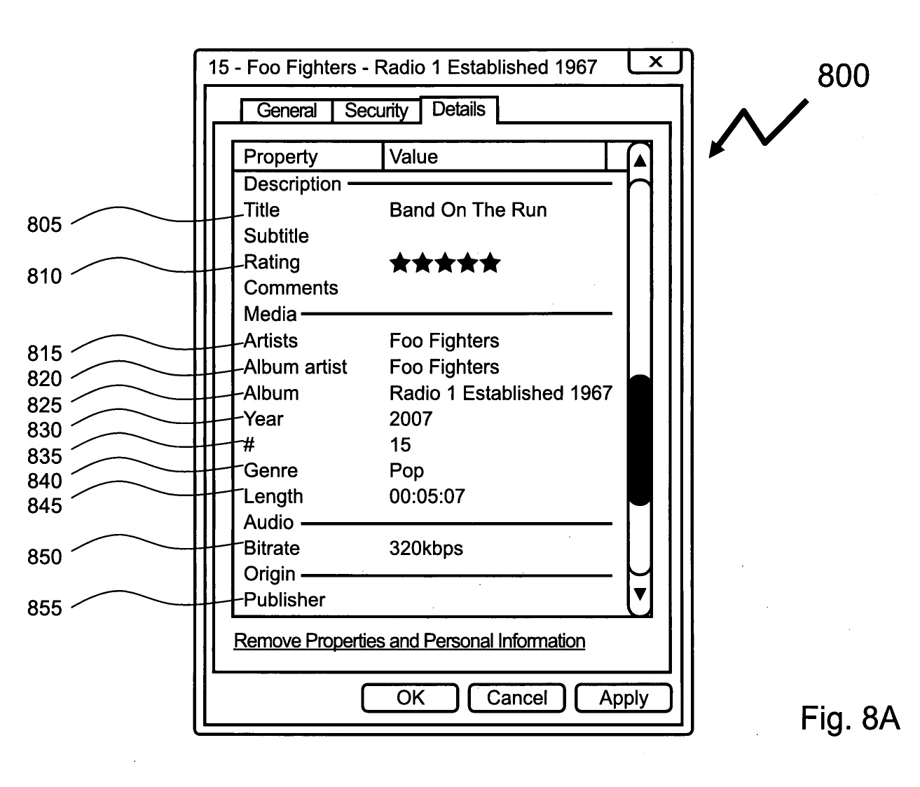

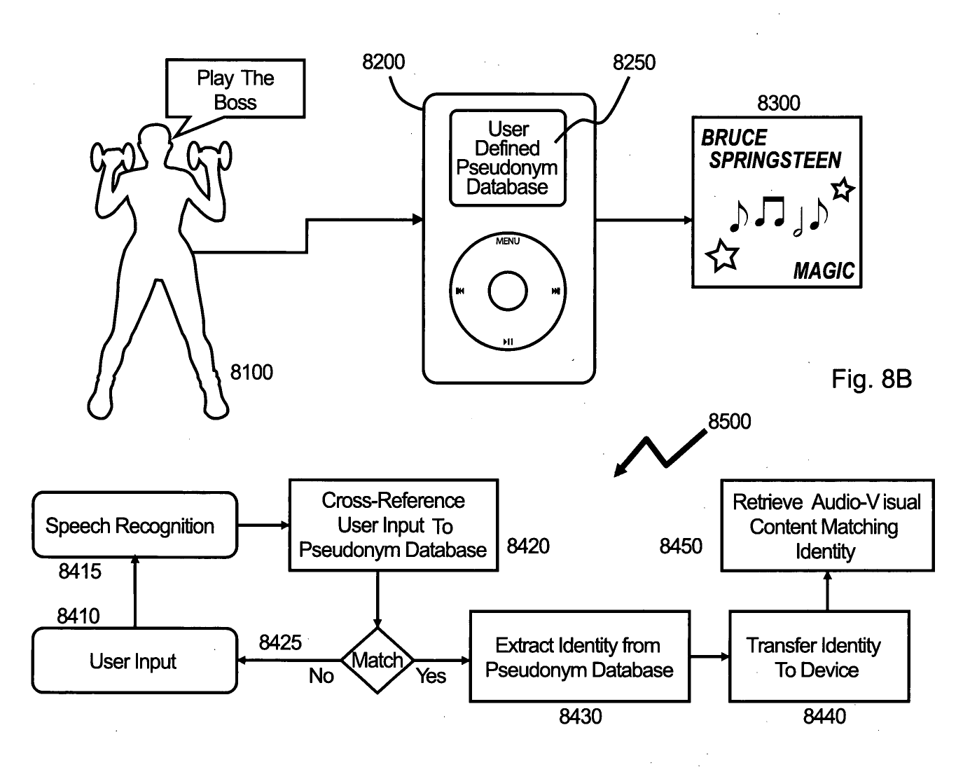

Referring to FIG. 8A, stored data 800 of an MP3 file according to an embodiment of the invention will now be discussed. Identified within the stored data are fields that include the following:

| | |
|---|---|
| Title 805 | Band on the Run |
| Rating 810 | No stars |
| Artist 815 | Foo Fighters |
| Album Artist 820 | Foo Fighters |
| Album 825 | Radio 1 Established 1967 |
| Year 830 | 2007 |
| Track/835 | 11 |
| Genre 840 | Pop |
| Length 845 | 5 minutes 7 seconds |
| Bit Rate 850 | 320 kbps |
| Publisher 855 | No data |

The user may select content based upon any field within the standard file format. Accordingly, the user may select for example Year 830 and then state the year “1973” whereupon all songs published in 1973 would be highlighted. The user may then say “Play” for all songs published in 1973 to be played or say “Refine” and select a second field to further filter such as Genre 840 followed by “Jazz.” Hence, at specific instances, the vocabulary being matched may be very narrow, such as title, artist, album, year, track, genre, length, and publisher or it may be very broad as in the name of the artist, song, and so forth where any word may be potentially part of the song title.

It would be evident that the user may select a variety of other filters, limited only by the information stored within the digital audio-visual file formats or associated with them. For example the user may wish to filter by producer, composer, beats per minute, or only female vocalists. It would be further desirable if the user were able to create pseudonyms of their own to associate with particular audio-visual content, artists, and so forth. In many instances, the user cannot remember the correct information but has an association to a different terminology. For example, the terminology may be an association with for example a person, a place, or an event. Accordingly, it is an aspect of the invention to allow the user to generate these pseudonyms and have them stored within their portable electronic device.

Referring to FIG. 8B such a use of pseudonyms is shown wherein a user 8100 states “Play The Boss” to their MP3 player 8200 that contains user defined pseudonym database 8250. As a result after speech recognition within the MP3 player 8200 a look-up into the user defined pseudonym database 8250 results in the association being retrieved for “The Boss” and resulting in Bruce Springsteen being played, in this instance the Bruce Springsteen Album ‘Magic’ 8300.

Such pseudonym retrieval is also shown as flow 8500 which begins with user input 8410, the speech then being processed within the speech recognition circuitry in step 8415. The resulting recognized speech is then cross-referenced to the pseudonym database in step 8420 and a decision made at step 8425 based upon a successful recognition. If no match is found the flow returns to step 8410 and awaits user input. If a match is found the matching identity is extracted from the pseudonym database in step 8430. This is then transferred to the application controlling audio-visual presentation to the user in step 8440 and the appropriate audio-visual content retrieved in step 8550 for presentation to the user.

Some examples of pseudonyms are listed below to illustrate the associations possible:

| | |
|---|---|
| “Patricia's Fave” | “Band on the Run” by Foo Fighters |
| “Bond” | “Diamonds are Forever” by Shirley Bassey |
| “Angry” | “FMLYHM” by Seether |
| “Patricia's Karaoke” | “Piece of Me” by Britney Spears |
| “Patricia” | “As The Rush Comes” by Armin van Buuren |
| “Driving Music” | “Beer Drinking Songs of Australia” by Slim Dusty |
| “Bob” | Bob Seger |
| “MoS” | Ministry of Sound |
| “Thingy” | Dolores O'Riordan |

Additionally some pseudonyms may be provided to address variants of words that have been used in titles of audio-visual content. For example, “Sk8ter Boy” by Avril Lavigne would not be an exact match with the user saying “Sk8ter” as a speech recognition match would be “skater”. Accordingly the pseudonym may be “Avril Skater”.

It would also be apparent that some pseudonyms may be pre-installed into the database as they are very well known, examples being “The Boss” for Bruce Springsteen, “King” for Elvis Presley, “BTO” for Bachman Turner Overdrive, and so forth. However, even with the ability of adding pseudonyms there is still the initial problem of identifying the track if the user has difficulty. Commonly the user will remember a portion of the song, either a single line, several lines, and more commonly the chorus.

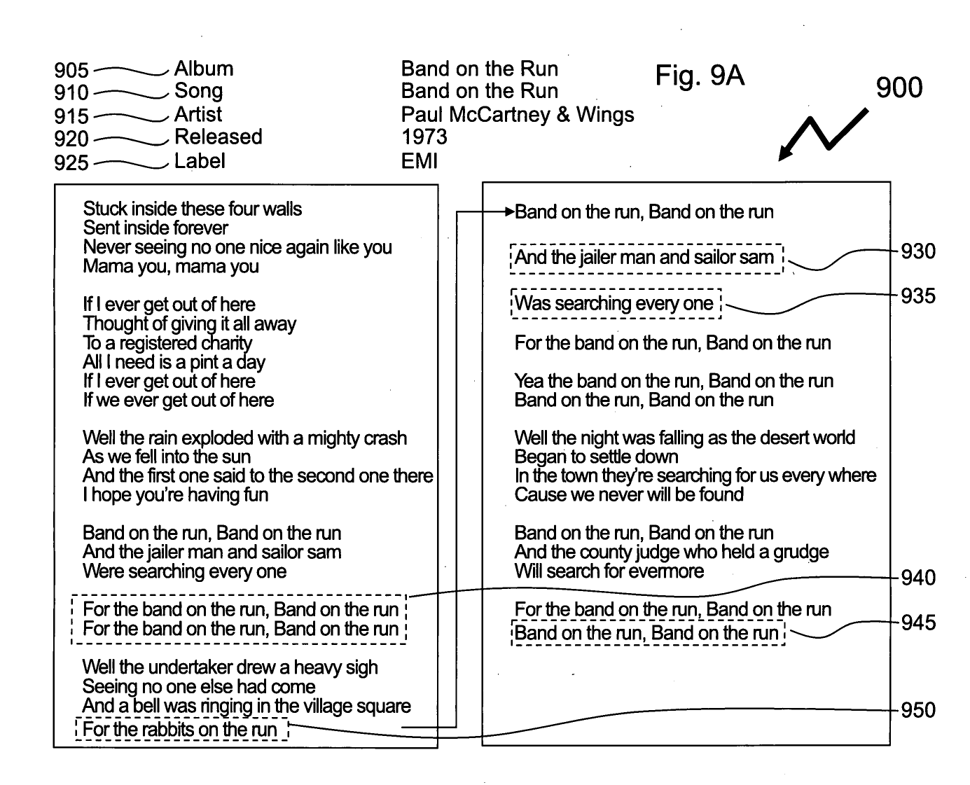

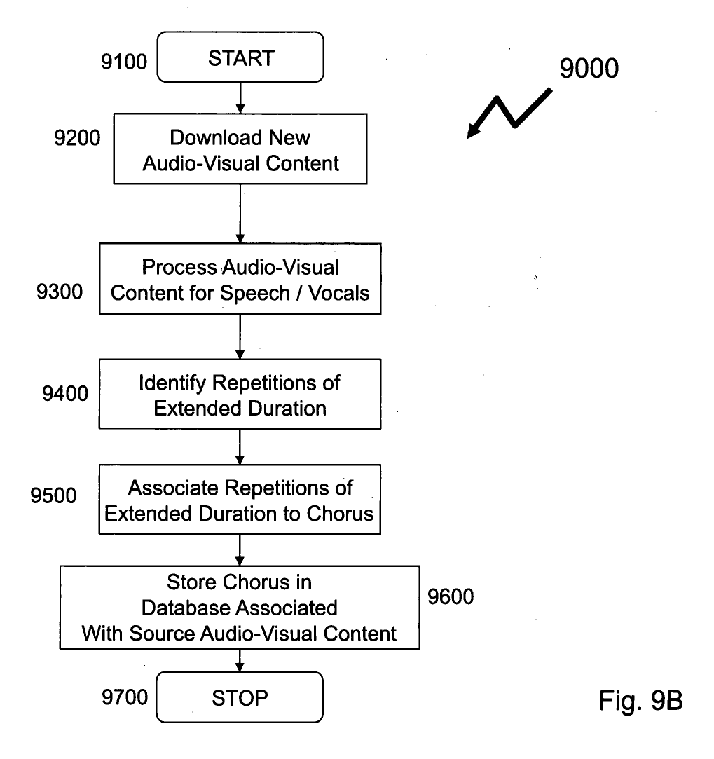

Accordingly as shown in FIG. 9A with respect to lyrics 900 audio-visual content may be identified and retrieved based upon the provision of speech containing a known portion of the song by the user. As shown, the lyrics 900 are associated with an audio-visual content having metadata including Album 905, Song 910, Artist 915, Released 920, and Label 925. In this example the lyrics 900 are for “Band on the Run” as originally recorded by Paul McCartney and Wings in 1973. A user may not remember the title if it had been a hidden track on an album and was simply “Track 13”. Accordingly a user may enter a single line such as “and the jailer man and sailor sam” 930, “for the rabbits on the run” 950 or “was searching every one” 935 wherein these are memorable lines for the user who can hear the song in their head when searching.

Alternatively, the user may enter multiple lines “and the jailer man and sailor sam was searching every one” being 930 and 935 combined. Equally they may use one line “band on the run, band on the run” 945 from the chorus or provide the complete chorus “for the band on the run, band on the run, for the band on the run, band on the run” 940.

In the downloading of new audio-visual content the portable electronic device may automatically access a lyrics database to associate with the audio-visual content. Such a file association would add a small overhead in the storage of audio-visual content, as a typical lyrics text file would be of the order 20 kb-50 kb compared with typical audio data files of between 3 Mb-6 Mb. However, it would also be possible for the speech recognition software to process the audio information to generate the lyrics completely or simply isolate and extract a chorus. Such a process is illustrated in FIG. 9B with recognition flow 9000.

Recognition flow 9000 starts at step 9100 with the recognition within the applications running on a multi-media device of the user. This content is then downloaded in step 9200 ready for speech processing whereupon it is processed in step 9300 and stored within memory. Next at step 9400, the extracted “speech” is analyzed to identify repetitions of an extended duration, thereby avoiding noting single words, which are then associated to a chorus in step 9500. This chorus is then stored in association with the original audio-visual content in step 9600 for subsequent searching from the command speech entered by the user, whereupon the process moves to step 9700 and stops.

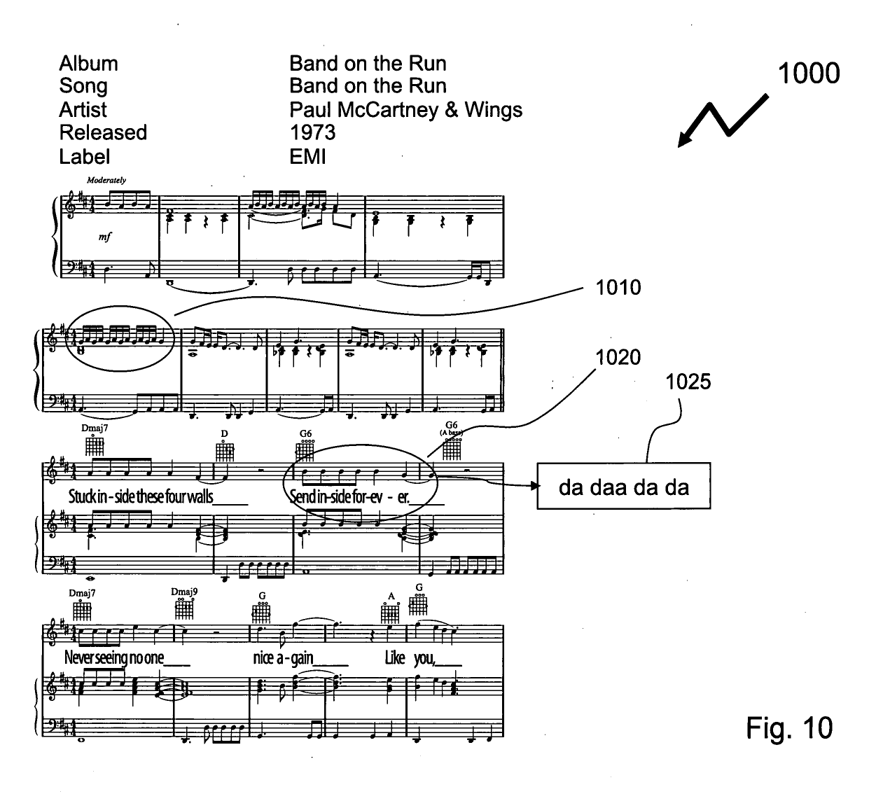

The technique of speech recognition for lyrics may be further extended as shown in FIG. 10 with the identification of a beat or riff from audio input from the user. Shown in FIG. 10 is sheet music 1000 showing the tune for “Band on the Run” and showing two samples 1010 and 1020 of music. One of these samples, sample 1020 is also shown as vocalized music phrase 1025. Hence, the user may vocalize the vocalized music phrase which would be searched against the audio-visual content for a match.

Alternatively, rather than seeking a match to the vocalized music phrase 1025 the matching is based upon the extraction of base form timing within the vocalized music phrase 1025 and matching this to potential content.

Within the embodiments described supra in respect of the provisioning of speech based information for the searching and retrieval of audio-visual content to a user the actual triggering of activities upon a device supporting audio-visual content has been similarly considered to be a spoken word, for example searching by their spoken name of the song and the playing with the word “Play”. However, in many instances the speech recognition will return a series of options that would be displayed to the user allowing them to select the content they wish to access. Such a list may for example be very similar to those presented supra in respect of FIG. 4B but navigated through verbal commands rather than scrolling and clicking as presented in respect of the prior art. Alternatively, the selection of an option from the list may be triggered from other audio inputs such as a number of claps, clicks of the fingers, clucks with the mouth, and so forth. Similarly additional elements of the hardware the user is accessing audio-visual content may provide other options such as counting the clicks of a button or other haptic interface, or even tracking the user's eye movement through a camera.

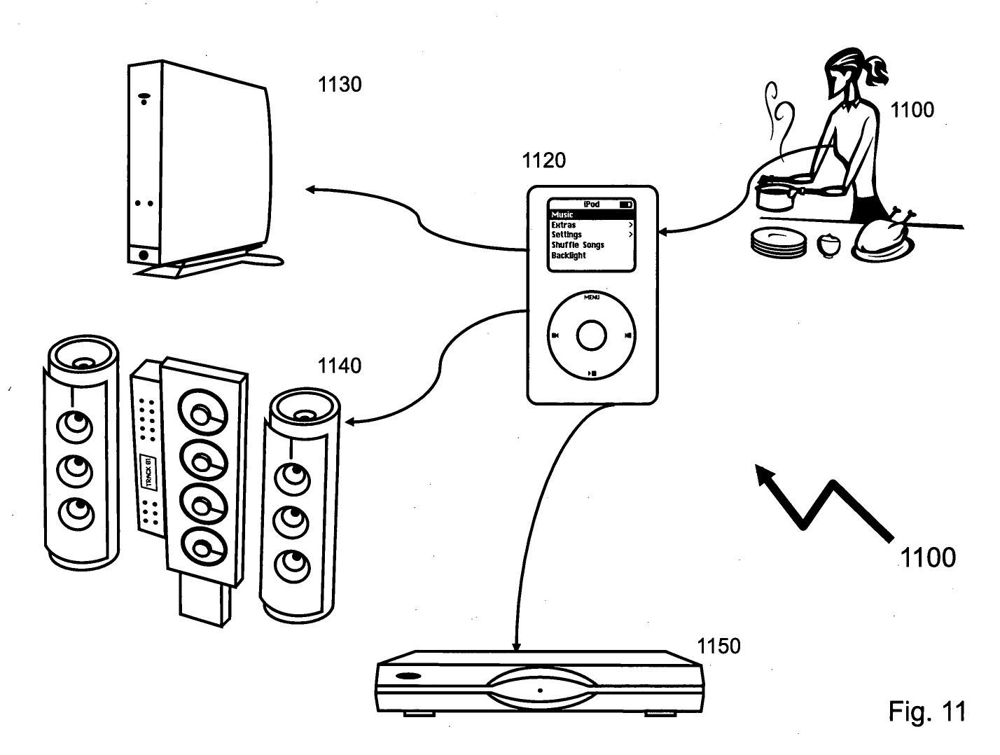

It would be further beneficial if the user could exploit the embodiments of the invention described supra in respect of controlling other audio-visual equipment from their portable electronic device. Accordingly, shown in FIG. 11 is remote controller scenario 1100 wherein a user 1110 accesses their portable electronic device, in this example iPod™ classic 1120 to select for example a song, which in this case is “Loose” by Nelly Furtado 1125. Once selected, however, the song is not played upon their iPod™ classic 1120 but their home audio system 1140. Accordingly based upon the audio-visual content selected the content may be displayed through other devices including gaming controller 1130 and HD personal video recorder 1150. In this manner the pseudonyms and so forth established by the user within the iPod™ classic 1120 do not have to be present within all other systems, nor does speech recognition as the iPod™ classic 1120 transfers conventional digital identifier data.

Optionally the remote controller, such as iPod™ classic 1120, accesses the “parent” device such as HD personal video recorder to identify content, or transfers the content from the iPod™ classic 1120 to the HD personal video recorder, or maintains a database of content on other systems which is periodically updated.

Numerous other embodiments may be envisaged without departing from the spirit or scope of the invention.

What is claimed is:

1. A method for providing to a user a selection of at least one content file of a plurality of content files, the method comprising:
storing in a database at least one association between a selection term and at least one content identifier identifying the at least one content file;
receiving an audio signal from the user, the audio signal comprising a spoken term;
converting the spoken term of the audio signal into a recognized term with use of a speech recognition circuit;
searching the database and determining that the recognized term matches the selection term of the at least one association;
selecting the at least one content file identified by the at least one content identifier associated with the selection term; and
providing to the user the selection from the at least one content file selected.

2. A method according to claim 1 wherein the spoken term is a pseudonym for the selection.

3. A method according to claim 2 wherein the pseudonym is a mnemonic.

4. A method according to claim 3 wherein the step of storing comprises receiving from the user as input, the selection term and an identification of content for use in determining the at least one content identifier associated with the selection term.

5. A method according to claim 3 wherein the content identifier comprises metadata associated with the at least one content file.

6. A method according to claim 3 wherein providing to the user the selection from the at least one content file selected comprises:
in a case where the at least one content file is a single content file, providing the single content file to the user as the selection; and
in a case where the at least one content file is more than a single content file, providing the selection from a list of the at least one content file.

7. A method according to claim 6 wherein the list of the at least one content file comprises data relating to the at least one content file, and wherein providing the selection from a list of the at least one content file comprises:
receiving a user selection from the user, the user selection relating to a specific item of the data presented to the user identifying a specific content file of the at least one content file.

8. A method according to claim 7 wherein receiving the user selection from the user comprises receiving at least one of an audible command, a spoken word, an entry via a haptic interface, a facial gesture, a facial expression, and an input based on a motion of an eye of the user.

9. A method according to claim 3 wherein the at least one content file comprises at least one of a document file, an audio file, an image file, a video file, and an audio-visual file.

10. A method according to claim 1 wherein each content file of the selection of at least one content file comprises audio data, and wherein the spoken term is a portion of lyrics.

11. A method according to claim 10 wherein the step of storing comprises for each content file of the at least one content file:
converting the audio data into speech data with use of the speech recognition circuit;
identifying in the speech data a repeated term greater than a predetermined length;
storing the repeated term as the selection term; and
storing as the content identifier an identifier identifying the content file.

12. A method according to 11 wherein the repeated term is a chorus.

13. A method according to claim 11 wherein the predetermined length is one of a predetermined length of time, a predetermined number of syllables, and a predetermined number of words.

14. A method according to claim 1 wherein the speech recognition circuit is situated in a local device, and wherein providing to the user the selection from the at least one content file selected comprises:
transferring to a remote device from the local device the at least one content file selected; and
providing to the user from the remote device the at least one content file selected.

15. A method according to claim 1 wherein the speech recognition circuit is situated in a local device, wherein providing to the user the selection from the at least one content file selected comprises:
in a case where the at least one content file is a single content file:
transferring to a remote device from the local device the single content file; and
providing the single content file to the user from the remote device as the selection; and
in a case where the at least one content file is more than a single content file:
receiving a user selection from the user, the user selection relating to a specific item of data presented to the user relating to the at least one content file, the user selection identifying a specific content file of the at least one content file;
transferring to the remote device from the local device the specific content file; and
providing the specific content file to the user from the remote device as the selection.

16. A method according to claim 15 wherein receiving the user selection from the user comprises receiving at least one of an audible command, a spoken word, an entry via a haptic interface, a facial gesture, a facial expression, and an input based on a motion of an eye of the user.

17. A method according to claim 1 wherein the speech recognition circuit is situated in a local device, wherein the plurality of content files are stored in a remote device, and wherein selecting the at least one content file comprises:
transferring the at least one content identifier to the remote device; and
selecting the at least one content file stored in the remote device identified by the at least one identifier associated with the selection term.

18. A method according to claim 17 wherein the step of storing in a database comprises receiving from the user as input, the selection term and an identification of content for use in determining the at least one content identifier associated with the selection term.

19. A method according to claim 17 wherein the content identifier comprises metadata associated with the at least one content file.

20. A method according to claim 17 wherein providing to the user the selection from the at least one content file selected comprises:
in a case where the at least one content file is a single content file, providing the single content file on the remote device to the user as the selection; and
in a case where the at least one content file is more than a single content file, providing the selection from a list of the at least one content file.

21. A method according to claim 20 wherein the list of the at least one content file comprises data relating to the at least one content file, and wherein providing the selection from a list of the at least one content file comprises:
transferring the data relating to the at least one content file from the remote device to the local device;
receiving a user selection from the user, the user selection relating to a specific item of the data presented to the user identifying a specific content file of the at least one content file;
transferring the user selection from the local device to the remote device; and
providing on the remote device the specific content file identified by the user selection to the user as the selection.

22. A method according to claim 21 wherein receiving the user selection from the user comprises receiving at least one of an audible command, a spoken word, an entry via a haptic interface, a facial gesture, a facial expression, and an input based on a motion of an eye of the user.

23. A method according to claim 17 wherein the spoken term is a pseudonym for the selection.

24. A method according to claim 23 wherein the pseudonym is a mnemonic.

25. A method according to claim 17 wherein the at least one content file comprises at least one of a document file, an audio file, an image file, a video file, and an audio-visual file.

26. A method according to claim 17 wherein each content file of the selection of at least one content file comprises audio data, and wherein the spoken term is a portion of lyrics.

27. A method according to claim 17 wherein the step of storing in a database comprises:
identifying each content file of the plurality of content files stored in the remote device; and
generating the at least one content identifier identifying the at least one content file of the database from the identification of each content file of the plurality of content files.

28. A method for providing to a user a selection of at least one content file of a plurality of content files, each content file of the at least one content file comprising audio data, the method comprising:
receiving an audio signal from the user;
converting the audio signal into a digital representation with use of an audio circuit;
searching the plurality of content files and determining that the digital representation matches a portion of the audio data of the at least one content file;
selecting the at least one content file; and
providing to the user the at least one content file selected as the selection.

29. A method according to claim 28 wherein the audio data comprises music and the audio signal comprises vocalized music.

30. A method according to claim 29 wherein determining that the digital representation matches a portion of the audio data comprises: extracting an input base form timing from the vocalized music of the digital representation and determining if the input base form timing matches a base form timing of the music of the audio data.

31. A method according to claim 29 wherein the vocalized music comprises at least one of a beat, a tempo, and a riff.

32. A method according to claim 28 wherein the audio data comprises a song and the audio signal comprises user lyrics, wherein converting the audio signal into a digital representation is performed with use of a speech recognition circuit, wherein and digital representation comprises recognized lyrics converted by the speech recognition circuit from the user lyrics, and wherein determining that the digital representation matches a portion of the audio data comprises: extracting speech data from the song of the audio data and determining that the recognized lyrics match a portion of the speech data.

33. A method according to claim 28 wherein providing to the user the selection from the at least one content file selected comprises:
in a case where the at least one content file is a single content file, providing the single content file to the user as the selection; and
in a case where the at least one content file is more than a single content file, providing the selection from a list of the at least one content file.

34. A method according to claim 33 wherein the list of the at least one content file comprises data relating to the at least one content file, and wherein providing the selection from a list of the at least one content file comprises:
receiving a user selection from the user, the user selection relating to a specific item of the data presented to the user identifying a specific content file of the at least one content file.

35. A method according to claim 34 wherein receiving the user selection from the user comprises receiving at least one of an audible command, a spoken word, an entry via a haptic interface, a facial gesture, a facial expression, and an input based on a motion of an eye of the user.

36. A method for providing to a user a selection of at least one content file of a plurality of content files, each content file of the at least one content file comprising audio data, the method comprising:
selecting a content file with a portable audio player, the portable audio player comprising memory for storing of content files comprising audio data, the content file stored within the portable audio player;
providing a first signal indicative of the content file from the portable audio player to a second other audio player; and
in response to receiving the first signal playing on the second other audio player sound in dependence upon the audio data within the content file.
